(19) United States
(12) Patent Application Publication
(10) Pub. No.: US 2008/0162164 A1
(43) Pub. Date: Jul. 3, 2008

(54) Method and system for centralized management of sources of supply

(75) Inventors: Michael Segler, Wiesloch (DE); Thomas John, Weinheim (DE); Kristina Grunewald, Heidelberg (DE); Stefan Siebert, Hockenheim (DE); Thomas Gross-Boelting, Walldorf (DE); Bernhard Lokowandt, Heidelberg (DE); Michael Hartel, Heidelberg (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 11/647,775

(22) Filed: Dec. 29, 2006

(51) Int. Cl. G06Q 10/00

(52) U.S. Cl. 705/1

(57) ABSTRACT

Methods and systems for determining sources of supply are provided. The system for determining sources of supply is centralized so as to be accessible to a plurality of clients. Sources of supply may be determined and the results prioritized according to user defined criteria. Specifically, the system may offer or facilitate a reusable, centralized service that can data mine sources of supply, which are stored in a business object. These sources of supply may include transportation lane, purchase contract, scheduling agreement, material costing, and any other suitable sources of supply. In some cases, this example system can assign priorities to centralized sources of supply that may help make decisions easier for the planner.

### TECHNICAL FIELD

This disclosure relates to computer systems and methods and, more particularly, to methods and systems for identifying, determining, processing, or otherwise managing sources of supply for a product (or service).

### BACKGROUND

Products are typically manufactured from a number of different parts, each of which may be available from a number of different sources. The determination of which sources to select as suppliers for which parts is based on a variety of criteria such as, for example, the contract terms (e.g., price) between the manufacturer and a source, the quantity of parts available from a source, and the estimated time for a source to deliver parts to the manufacturer. Depending on the number of parts and the number of possible suppliers involved, a vast amount of data may need to be considered in making such a determination. To assist with this sourcing determination, a sourcing engine, which may be one or more computers programmed with computer code enabling them to identify sources of supply based on appropriate criteria, may be used.

### SUMMARY

The disclosure provides various embodiments of systems and methods for determining sources of supply for products. In one embodiment, a system includes a memory storing one or more data objects, each of the stored data related to a supply source. The system also includes one or more processors executing software causing them to receive requests for supply source determinations from a plurality of clients and to return, to each client that submitted a request, a list of one or more supply sources matching the request. Thus, one aspect of the disclosure is a sourcing engine implemented as a reusable and centralized solution that may be utilized by a number of different clients.

In another embodiment, a computerized method is provided for determining supply sources for a product. The method involves first receiving a request from a client for a source determination for a product. Then a plurality of supply sources is selected for the product. The selected supply sources are then prioritized based on rules. In some cases, the supply sources may be selected based on user defined criteria. In addition, the rules by which the selected supply sources are prioritized may also be user defined.

According to another embodiment, a computerized method for determining supply sources for a product is provided. According to the method, a request from a client for a source determination for a product is received. Then, a plurality of supply sources for the product is selected. Next, a means of transportation for at least one of the one or more supply sources is selected. The selected means of transportation is then merged with the at least one of the one or more supply sources. Next, a quota arrangement for the at least one of the one or more supply sources is selected. Then, the selected quota arrangement is merged with the at least one of the one or more supply sources. Finally, the selected supply sources are prioritized based on user defined rules. In other embodiments, the selected supply sources, means of transportation, and quota arrangements may be broken down to more detailed levels of information. According to another embodiment, the lateness of providing a source of supply may be calculated.

Moreover, some or all of these aspects may be further included in respective systems or other similar devices for executing, implementing, or otherwise supporting such software or methods. The details of these and other aspects and embodiments of the disclosure are set forth in the accompanying drawings and the description below. Other features, objects, and advantages of the various embodiments will be apparent from the description and drawings, as well as from the claims.

### DESCRIPTION OF DRAWINGS

FIG. 1 illustrates an example system for determining sources of supply in accordance with one embodiment of the present disclosure;

FIG. 2 illustrate detailed views of various portions of the data model for a source of supply business object in accordance with one embodiment of the present disclosure;

FIG. 3 illustrates an example method for determining sources of supply in accordance with the present disclosure; and

FIG. 4 illustrates another example method for determining sources of supply in accordance with the present disclosure.

### DETAILED DESCRIPTION

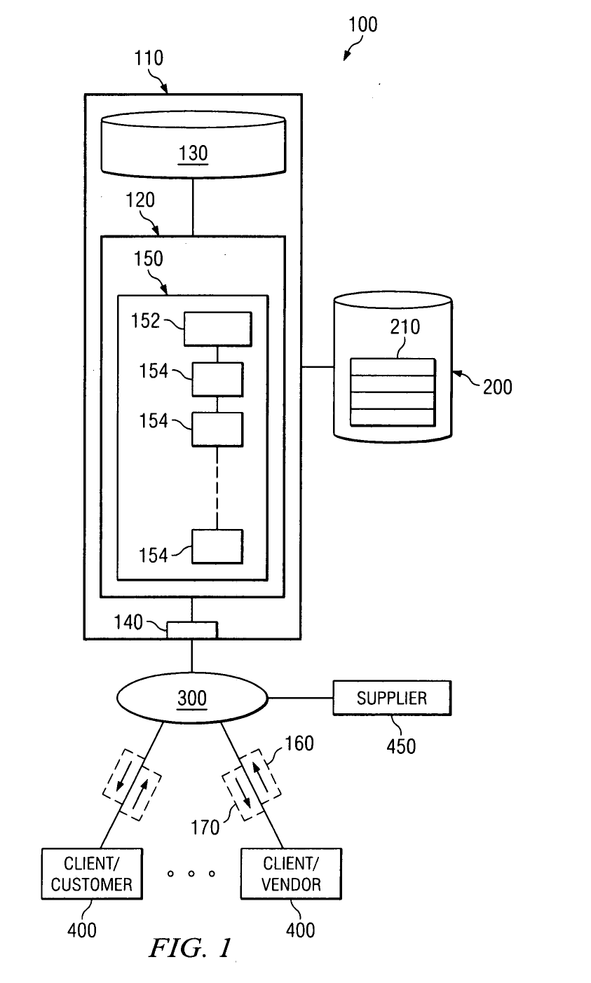

FIG. 1 illustrates an embodiment of the invention and the environment in which it operates. The illustrated sourcing system 100 includes or is communicably coupled with computer 110, one or more clients 400, one or more suppliers 450, at least some of which communicate across network 300. System 100 can provide high flexibility/performance through a logically centralized service or sourcing engine that is offered for heterogeneous sources of supply. For example, a source of supply may be implemented as an object that describes a logical link between a possible source of products and a possible target. These sources of supply may include transportation lane, purchasing contract, scheduling agreement, material costing, and any other suitable sources of supply. For example, a transportation lane can be a connection between two locations in a supply chain model used for planning cross-location product movements, a purchasing contract can be an outline purchase agreement that contains special conditions that are negotiated between a purchaser and a seller (for example price, target value or target quantity) that covers the supply of materials or the performance of services and can be valid for a specified period of time, and a scheduling agreement can be an outline agreement against which materials are procured at a series of predefined points in time over a certain period. System 100 can also offer extensibility by allowing the customer to define his own source of supply (such as an internal/external hybrid) and the respective business application to implement its own rules to influence the sourcing engine results (such as when one business module may want to data mine only certain sources of supply). In some cases, system 100 can data mine and then dynamically prioritize the results that can be based on customer's rules (such as internal production before external procurement). These prioritization rules can have a general part (that defines the customer's preferences) and a product specific part (sorting or prioritization requirements for that product or its category). Example sorting criteria include procurement type, fulfillment of quota, sourcing priority, and many others. For example, the customer can assign priorities to various values for each variable and the sourcing engine can load defaults values as well (a customer may not want to assign priorities to every single variable for every single product, instead just the special ones). System 100 may also offer dynamic quotes from various suppliers that change as prices change, as well as offer quickly analyze the product category hierarchy (e.g. highest level is consumer products, then broken down into electronics, groceries, and perhaps further broken down).

Moreover, system 100 often offers estimation of the “lateness” of future delivery of supply. For example, the user can supply various parameters (such as maximum “lateness”, or a date/time range that the source of supply must be valid) that can automatically filter results. In this example, system 100 might maintain supply information such as transportation duration (truck is slower than train is slower than airplane) and special transportation requirements (milk not to be shipped with gasoline). System 100 may also analyze these sources of supplies at a company level, at a site level, and so forth and may divide the production model into segments (divide the production of a pencil into wood production and lead production); the sourcing engine can dynamically respond to various situations that arise in this segmentation (the wood shipment is damaged, so the sourcing engine should quickly respond).

In even further implementations, system 100 may automatically learn from product movement and may offer determination of sales determination as the source of supply to the customer—a “push” feature. System 100 may also process “abstract” costs in addition to “real” costs in dollars in cents: preferred vendor status, transportation time, product quality, rough capacity decisions for bottlenecks, complexity of order process or legal hurdles, “feelings” and other reputation metrics. The sourcing engine can typically perform material costing estimates for multiple vendors; for example, the sourcing engine may reduce purchase costs in order to meet pricing demands from customers.

Turning to the illustration, system 100 is typically a distributed environment that includes a variety of heterogeneous sub-systems and applications that communicate with each other. For example, the relatively centralized sourcing engine may be executed on illustrated computer 100 for utilization by various clients, partners, customers, and so on. Computer 110 comprises an electronic computing device operable to receive, transmit, process and store data associated with system 100. Computer 110 is generally intended to encompass any suitable processing device. For example, computer 110 may comprise a server. In addition, sourcing system 100 may be implemented using computers other than servers, as well as a server pool. Indeed, computer 110 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Computer 110 may be adapted to execute any operating system including Linux, UNIX, Windows Server, or any other suitable operating system.

Computer 110 includes processor 120. Processor 120 executes instructions and manipulates data to perform the operations of computer 110 such as, for example, a central processing unit (CPU), a blade, an application specific integrated circuit (ASIC), or a field-programmable gate array (FPGA). Although FIG. 1 illustrates a single processor 120 in computer 110, multiple processors 120 may be used according to particular needs and reference to processor 120 is meant to include multiple processors 120 where applicable. In the illustrated embodiment, processor 120 executes application 150.

At a high level, the application 150 is operable to receive and/or process requests 160 from clients 400 and present results 170 to the particular client. The requests 160 include requests for sourcing determinations for a particular product or product category. The results 170 include a list of one or more possible supply sources for the product or product category identified in the request. In certain cases, the functionality of application 150 may be included in a component 152 as well as one or more subcomponents 154, each typically operable to provide some service or sub-service. In short, application 150 may be a business application offering a service oriented architecture (SOA) or may represent one of these services or business objects, namely a sourcing engine.

Regardless of the particular implementation, “software” may include software, firmware, wired or programmed hardware, or any combination thereof as appropriate. Indeed, application 150 may be written or described in any appropriate computer language including C, C++, Java, Visual Basic, assembler, Perl, any suitable version of 4GL, as well as others. For example, returning to the above described application, the application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while functionality of application 150 may be included within a number of components and sub-components, as mentioned above, application 150 may also be a single multi-tasked module that implements the various features and functionality through various objects, methods, or other processes. Further, while illustrated as internal to computer 110, one or more processes associated with application 150 may be stored, referenced, or executed remotely. For example, a portion of application 150 may be a service that is remotely called. Moreover, application 150 may be a child or sub-module of another software module or enterprise application (not illustrated) without departing from the scope of this disclosure.

Computer 110 may include local memory 130, which may function as a possible supplement to or as a portion of repository 200, discussed below. Memory 130 may include any memory or database module and may take the form of volatile or non-volatile memory including, without limitation, magnetic media, optical media, random access memory (RAM), read-only memory (ROM), removable media, or any other suitable local or remote memory component. For example, memory 130 may include, point to, reference, or otherwise store a business object repository. In some embodiments, the business object repository may be stored in one or more tables in a relational database described in terms of SQL statements or scripts. In the same or other embodiments, the business object repository may also be formatted, stored, or defined as various data structures in text files, eXtensible Markup Language (“XML”) documents, Virtual Storage Access Method (“VSAM”) files, flat files, Btrieve files, comma-separated-value (“CSV”) files, internal variables, or one or more libraries. In short, the business object repository may comprise one table or file or a plurality of tables or files stored on one computer or across a plurality of computers in any appropriate format. Indeed, some or all of the business object repository may be local or remote without departing from the scope of this disclosure and store any type of appropriate data. In particular embodiments, the business object repository may access the business objects in response to queries from clients 400.

These business objects may represent organized data relating to some project or endeavor, which may or may not be linked, with each object having one or more states related to the object. Each of the states, in turn, is associated with data that pertains to various modifiable parameters of the individual states of the object. One type of data modeling that includes multiple objects with each having multiple states, and each state having multiple instances of changes to the state's modifiable parameters is the business object model. Briefly, the overall structure of a business object model ensures the consistency of the interfaces that are derived from the business object model. The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

The business object is thus a capsule with an internal hierarchical structure, behavior offered by its operations, and integrity constraints. Business objects are generally semantically disjointed, i.e., the same business information is represented once. In some embodiments, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are generally arranged from the top to the bottom based on defined order of the business areas, e.g., finance could be arranged at the top of the business object model with CRM below finance and SRM below CRM. To ensure the consistency of interfaces, the business object model may be built using standardized data types as well as packages to group related elements together, and package templates and entity templates to specify the arrangement of packages and entities within the structure.

Computer 110 may also include interface 140 for communicating with other computer systems, such as clients 400, over network 300 in a client-server or other distributed environment. In certain embodiments, computer 110 receives data from internal or external senders through interface 140 for storage in memory 130, for storage in repository 200, and/or processing by processor 120. Generally, interface 140 comprises logic encoded in software and/or hardware in a suitable combination and operable to communicate with network 300. More specifically, interface 140 may comprise software supporting one or more communications protocols associated with communications network 300 or hardware operable to communicate physical signals.

As illustrated, computer 110 is communicably coupled with a remote repository 200 over a portion of network 300. Repository 200 is any intra-enterprise, inter-enterprise, regional, nationwide, or substantially national electronic storage facility, data processing center, or archive that allows for one or a plurality of clients 400 (as well as computers 110) to dynamically store and retrieve data elements, which may include any business, enterprise, application or other transaction data and metadata. Repository 200 also includes business objects 210 that are related to various supply sources, as discussed further below. Repository 200 may be a central database communicably coupled with one or more servers computers 110 and clients 400 via a virtual private network (VPN), SSH (secure Shell) tunnel, or other secure network connection. Repository 200 may be physically or logically located at any appropriate location including in one of the example enterprises or off-shore, so long as it remains operable to store information associated with sourcing system 100 and communicate such data to at least a subset of plurality of clients 400 (perhaps via computer 110).

Network 300 facilitates wireless or wireline communication between computer 110 and any other local or remote computer, such as clients 400 and suppliers 450. Network 300 may be all or a portion of an enterprise or secured network. In another example, network 300 may be a VPN merely between computer 110 and client 400 across wireline or wireless link. Such an example wireless link may be via 802.11a, 802.11b, 802.11 g, 802.20, WiMax, and many others. While illustrated as a single or continuous network, network 300 may be logically divided into various sub-nets or virtual networks without departing from the scope of this disclosure, so long as at least portion of network 300 may facilitate communications between computer 110 and at least one client 400. For example, computer 110 may be communicably coupled to repository 200 through one sub-net while communicably coupled to a particular client 400 through another. Thus, network 300 encompasses any internal or external network, networks, sub-network, or combination thereof operable to facilitate communications between various computing components. Network 300 may communicate, for example, Internet Protocol (IP) packets, Frame Relay frames, Asynchronous Transfer Mode (ATM) cells, voice, video, data, and other suitable information between network addresses. Network 300 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 300 may be a secure network associated with the enterprise and certain local or remote clients 400.

Client 400 is any computing device operable to connect or communicate with computer 110 over network 300 using any communication link in order to request and receive supply source information from sourcing system 100. At a high level, each client 400 comprises an electronic computing device operable to receive, transmit, process and store any appropriate data associated with sourcing system 100. A client 400 may be a computing device operated by a human user, such as a procurement planner, sending a request to sourcing system 100 for a determination of supply sources for one or more products. Alternatively, client 400 may be a computing device executing an application or module which sends a request for a determination of supply sources to sourcing system 100 without any human intervention. It will be understood that there may be any number of clients 400 communicably coupled to computer 110.

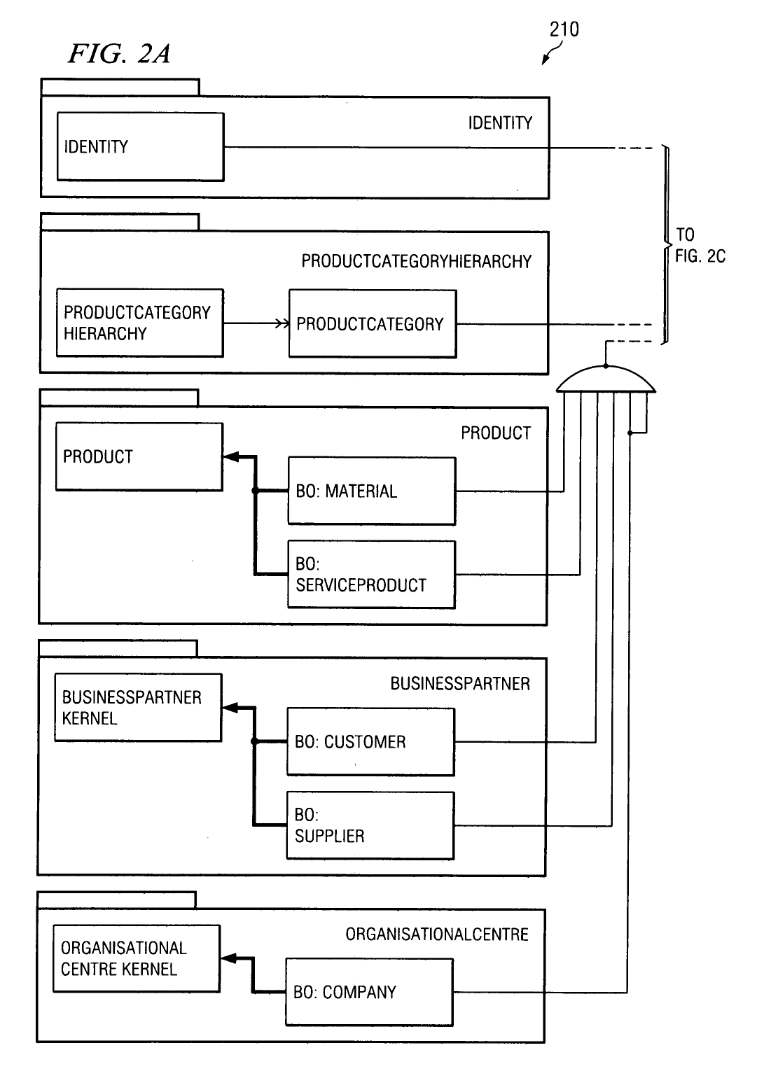

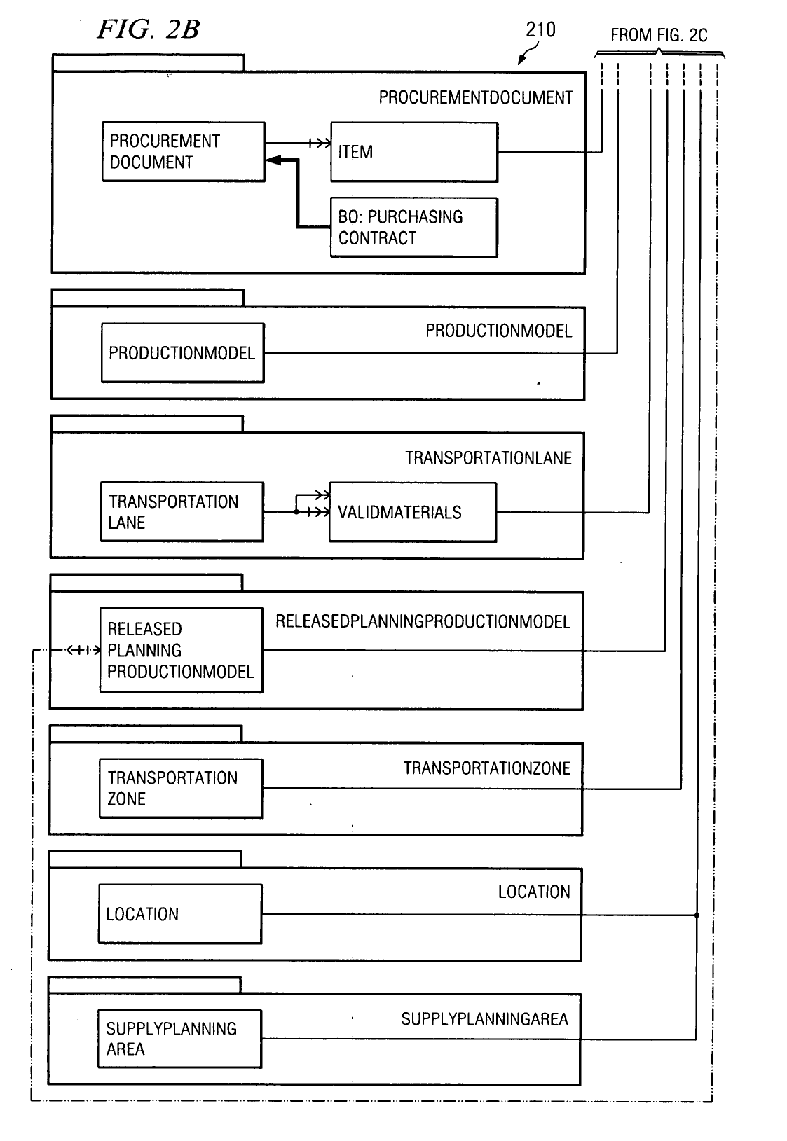

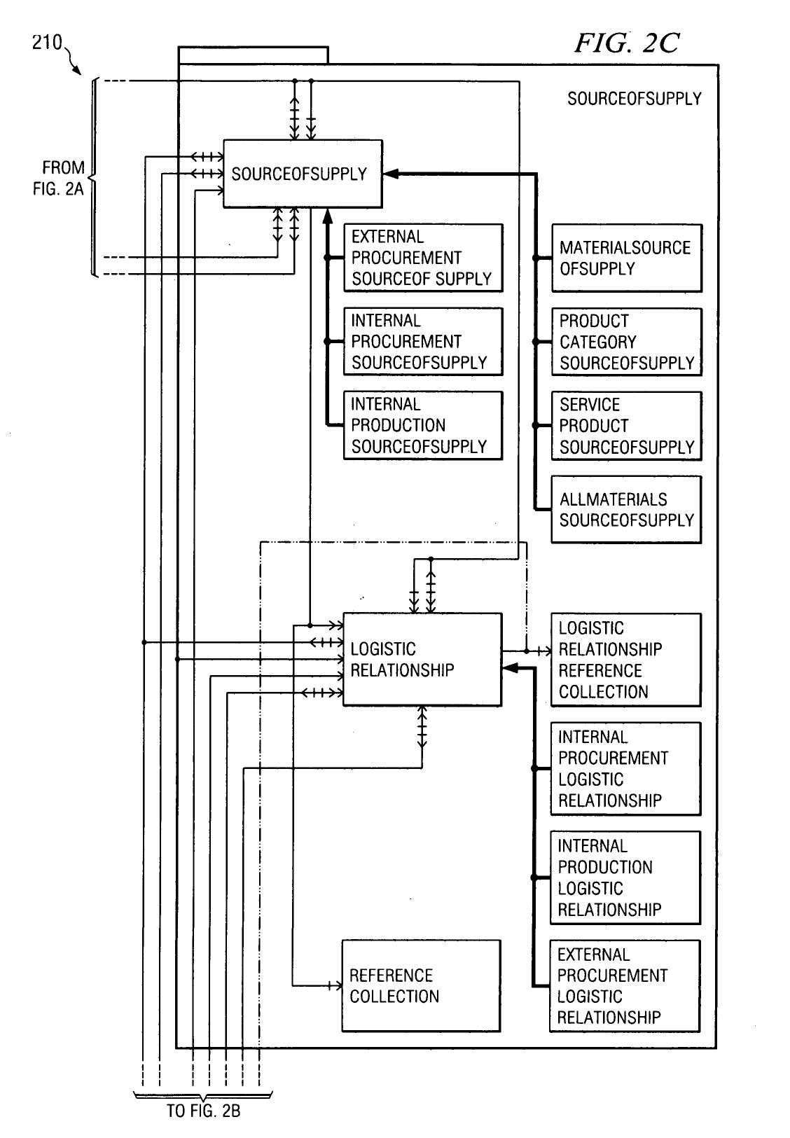

FIG. 2 illustrate an example data model for representing Sources of Supply that provides an overall view of the data model. The example Sources of Supply business object (“SOS BO”) illustrated in FIG. 2 may be used to represent a source for the external and internal procurement of products. This SOS BO contains a business relationship, an option for producing products or for procuring them internally, as well as lot size margins and costs.

As shown in FIG. 2, the example SOS BO may refer to the following original business objects, or adopt data from them: ProductionModel, TransportationLane and PurchasingingContract. The example SOS BO may occur in the following complete and disjoint specializations: ExternalProcurementSourceOfSupply (a source of supply for the external procurement of products and contains all the parameters required for that purpose), InternalProcurementSourceOfSupply (a source of supply for the internal procurement of products and contains all the parameters required for that purpose) and InternalProductionSourceOfSupply (a source of supply for the internal production of materials and contains all the parameters required for that purpose). In the case of the external and internal procurement of materials, the example SOS BO may occur in the following complete and disjoint specializations: MaterialSourceOfSupply (a source of supply for the procurement of a particular material), ServiceProductSourceOfSupply (a source of supply for the procurement of a particular service), ProductCategorySourceOfSupply (a source of supply for the procurement of products in a particular product category) and AllMaterialsSourceOfSupply (a source of supply that can be used for the procurement of all materials).

The example SOS BO may have a root node containing the following example elements, which may be defined by a data type SourceOfSupplyElements:
UUID—Universal identifier of the source of supply.
SystemAdministrativeData—The administrative data recorded by the system. This data may include system users and change dates/times.
SenderBusinessPartnerUUID—Business partner, that sends the product, that is to be procured.
SenderOrganisationalCentreUUID—OrganisationalCentre, that sends the product, that is to be procured.
SenderOrganisationalCentreBusinessCharacterCode—Coded representation of the business role of the SenderOrganisationalCentre. Possible value is ‘Company’.
RecipientBusinessPartnerUUID—Business partner, that receives the product, that is to be procured.
RecipientOrganisationalCentreUUID—OrganisationalCentre, that receives the product, that is to be procured.
RecipientOrganisationalCentreBusinessCharacterCode—Coded representation of the business role of the RecipientOrganisationalCentre. Possible value is ‘Company’.
BaseObjectNodeReference—Universal reference of the object from which the source of supply was replicated. A source of supply may be replicated from a material specific transportation lane, from an item of a purchasing contract or a production model. The UUID should be specified, the ObjectNodeId should not be specified.
ProductUUID—Universal identifier of the product to be procured.
ProductTypeCode—Coded representation of the type of the product to be procured. The possible types are: Material and ServiceProduct.
ProductCategoryHierarchyProductCategoryUUID—Universal identifier of the product category to be procured.
ProductsSpecificationDetailLevelCode—Coded representation of the type of the specification level of the product to be procured.
CatalogueReference—Unique reference to a catalog or an object in a catalog.
ProductSellerID—An identifier that a party assigns to a product.
ProcurementCategoryCode—Coded representation of the procurement category.
PriorityValue—Priority according to which the source of supply is taken into account in procurement.
ValidityPeriod—Validity period of the source of supply.
MinimumLotsizeQuantity—Smallest possible lot size during procurement.
MinimumLotsizeQuantityTypeCode—Coded representation of the type of the MinimumLotsizeQuantity.
MaximumLotsizeQuantity—Largest possible lot size during procurement.
MaximumLotsizeQuantityTypeCode—Coded representation of the type of the MaximumLotsizeQuantity.
TargetQuantity—Target quantity for a material to be delivered, for example, in a contract item.
TargetQuantityTypeCode—Coded representation of the type of the TargetQuantity.
PlannedDeliveryDuration—Planned delivery time, including transportation time.
PlannedDeliveryDurationRelevanceIndicator—Indicates whether the PlannedDeliveryDuration has to be considered.
Status—Current status of the SourceOfSupply. It is defined by the data type SourceOfSupplyStatus. It consists of the following status variables: LifeCycleStatusCode (describes stages in the life of a SourceOfSupply).

The example SOS BO of FIG. 2 may have the following inbound aggregation relationships:
From the business object PurchasingContract/Item: PurchasingContractItem—The purchasing contract item for which the source of supply was created.
From the business object TransportationLaneValidMaterials: TransportationLaneValidMaterials—The material-specific transportation lane from which the source of supply was created.
From the business object ProductionModel: ProductionModel—The ProductionModel for which the source of supply was created.

The example SOS BO of FIG. 2 may have the following inbound association relationships:
From the business object Supplier: Supplier—Supplier of the material to be obtained.
From the business object Customer: Customer—Customer of the material to be obtained.
From the business object Company: SenderCompany—A financially and legally independent, geographically unbound organizational center registered under business law. Sender of the material to be obtained.
From the business object Company: RecipientCompany—A financially and legally independent, geographically unbound organizational center registered under business law. Recipient of the material to be obtained.
From the business object Material: Material—The material for the material-specific source of supply.
From the business object ServiceProduct: ServiceProduct—The service for a service specific source of supply.
From the business object ProductCategoryHierarchy/ProductCategory: ProductCategory—The product category for the product-category-specific source of supply.
From the business object Identity: CreationIdentity—Identifies the Identity that created the SourceOfSupply.
From the business object Identity: LastChangedIdentity—Identifies the Identity that changed the SourceOfSupply
   In the example SOS BO of FIG. 2, the root node may have composition relationships to the following subordinate nodes: LogisticRelationship and ReferenceCollection. The example SOS BO of FIG. 2 may also include the following queries:
QueryByProductAndRecipientOrganisationalCentre: Typically provides a list of all sources of supply for a particular product and a particular organizational center that is the recipient of this product. The sources of supply can be valid for the specified point in time. The query elements can be defined by the datatype SourceOfSupplyProductAndRecipientOrganisationalCentreQueryElements which may include the following elements: ProductUUID (note: Sources of supply that refer to the product category of the specified product, to a product category on the above hierarchy level of the product category of the specified product or to all materials can also be returned), CatalogueReference, ProductSellerID, ProductTypeCode, RecipientOrganisationalCentreUUID, SenderBusinessPartnerUUID, RequirementDateTime, RequiredLotsizeQuantity (the system returns the sources of supply for which the RequiredLotsizeQuantity is larger or the same as the MinimumLotsizeQuantity, and for which the RequiredLotsizeQuantity is smaller or the same as the MaximumLotsizeQuantity), BaseObjectTypeCode, BaseObjectNodeTypeCode, ProcurementCategoryCode and LifeCycleStatusCode.
QueryByProductAndRecipientBusinessPartner: Typically provides a list of all sources of supply for a particular product and a particular business partner that is the recipient of this product. The sources of supply can be valid for the specified point in time. The query elements can be defined by the datatype SourceOfSupplySourceOfSupplyProductAndRecipientBusinessPartnerQuery Elements, which may include the following elements: ProductUUID (note: Sources of supply that refer to the product category of the specified product, to a product category on the above hierarchy level of the product category of the specified product or to all materials can also be returned), CatalogueReference, ProductSellerID, ProductTypeCode, RecipientBusinessPartnerUUID, SenderBusinessPartnerUUID, RequirementDateTime, RequiredLotsizeQuantity (the system returns the sources of supply for which the RequiredLotsizeQuantity is larger or the same as the MinimumLotsizeQuantity, and for which the RequiredLotsizeQuantity is smaller or the same as the MaximumLotsizeQuantity), BaseObjectTypeCode, BaseObjectNodeTypeCode, ProcurementCategoryCode and LifeCycleStatusCode.
QueryByProductCategoryAndRecipientOrganisationalCentre: Typically provides a list of all sources of supply for a particular product category and a particular organizational center that is the recipient of the products in this product category. The sources of supply can be valid for the specified point in time. The query elements can be defined by the datatype SourceOfSupplyProductCategoryAndRecipientOrganisationalCentreQueryElements, which may include the following elements: ProductCategoryHierarchyProductCategoryUUID (note: Sources of supply that refer to a product category on the above hierarchy level of the product category can also be returned), RecipientOrganisationalCentreUUID, SenderBusinessPartnerUUID, RequirementDateTime, RequiredLotsizeQuantity (the system returns the sources of supply for which the RequiredLotsizeQuantity is larger or the same as the MinimumLotsizeQuantity, and for which the RequiredLotsizeQuantity is smaller or the same as the MaximumLotsizeQuantity), BaseObjectTypeCode, BaseObjectNodeTypeCode, ProcurementCategoryCode and LifeCycleStatusCode.
QueryByProductCategoryAndRecipientBusinessPartner: Typically provides a list of all sources of supply for a particular product category and a particular business partner that is the recipient of the products in this product category. The sources of supply can be valid for the specified point in time. The query elements can be defined by the data type SourceOfSupplySourceOfSupplyProductCategoryAndRecipientBusinessPartnerQueryElements, which may include the following elements: ProductCategoryHierarchyProductCategoryUUID (note: Sources of supply that refer to a product category on the above hierarchy level of the product category can also be returned), RecipientBusinessPartnerUUID, SenderBusinessPartnerUUID, RequirementDateTime, RequiredLotsizeQuantity (the system returns the sources of supply for which the RequiredLotsizeQuantity is larger or the same as the MinimumLotsizeQuantity, and for which the RequiredLotsizeQuantity is smaller or the same as the MaximumLotsizeQuantity), BaseObjectTypeCode, BaseObjectNodeTypeCode, ProcurementCategoryCode and LifeCycleStatusCode.
QueryByProductIDAndRecipientCompanyID: Typically provides a list of all sources of supply for a particular product and a particular company that is the recipient of this product. The sources of supply can be valid for the specified point in time. The query elements can be defined by the datatype SourceOfSupplyProductIDAndRecipientCompanyIDQueryElements, which may include the following elements: Product_IdentificationProductID, ProductTypeCode, RecipientCompany_ID, RequirementDateTime, LifeCycleStatusCode and CreationUserAccountID.
QueryByProductCategoryIDAndRecipientCompanyID: Typically provides a list of all sources of supply for a particular product category and a particular company that is the recipient of this product category. The sources of supply can be valid for the specified point in time. The query elements can be defined by the datatype SourceOfSupplyProductCategoryIDAndRecipientCompanyIDQueryElements, which may include the following elements: ProductCategoryHierarchy_ProductCategoryIDKey, RecipientCompany_ID, RequirementDateTime, LifeCycleStatusCode and CreationUserAccountID.
QueryByProductAndRecipientOrganisationalCentreAndSenderBusinessPartne r: Typically provides a list of all sources of supply for a particular product and a particular organizational centre that is the recipient of the product and a particular business partner that is the sender of this product. The sources of supply can be valid within the specified time period. The query elements can be defined by the datatype SourceOfSupplyProductAndRecipientOrgansiationalCentreAndSenderBusinessPartnerQueryElements, which may include the following elements: ProductUUID, RecipientOrganisationalCentreUUID, SenderBusinessPartnerUUID, ValidityDateTimePeriod (note: Sources Of Supply that can be valid within this time period are returned) and LifeCycleStatusCode.
QueryByElements: Typically provides a list of all sources of supply which refer to a particular business object or to a node of a business object. The query elements can be defined by the data type SourceOfSupplyElementsQueryElements, which may include the following elements: BusinessPartnerUUID, OrganisationalCentreUUID, BaseObjectNodeReference, ProductUUID, ProductCategoryHierarchyProductCategoryUUID and LifeCycleStatusCode.
QueryByPurchasingContractIdAndPurchasingContractItemID: Typically provides a list of all sources of supply which refer to a particular purchasing contract item. The query elements can be defined by the data type SourceOfSupplyPurchasingContractIdAndPurchasingContractItemIdQueryElements, which may include the following elements: ReferenceCollectionPurchasingContractID, ReferenceCollectionPurchasingContractItemID and LifeCycleStatusCode.

The example SOS BO of FIG. 2 may include a ReferenceCollection node that contains the human-readable Identifiers for the References of the SourceOfSupply. The node ReferenceCollection may contain the following elements, which may be defined by the data type SourceOfSupplyReferenceCollectionElements: PurchasingContractID (Unique identifier of a contract that defines the business relationship), PurchasingContractItemID (Unique identifier of an item of the contract that defines the business relationship), and PurchasingContractItemKey (Alternative key of the LogisticRelationshipReferenceCollection. Elements of the alternative key may include PurchasingContractId and PurchasingContractItemId).

The example SOS BO may include a LogisticRelationship node that represents a relationship between two locations that is used to procure and produce products. It defines logistical characteristics. The two locations may also be identical. This often occurs in the case of the production of materials. A logistical source of supply may reference the following original business objects: ReleasedPlanningProductionModel, PurchasingContract and TransportationLane. Also, if the goods are obtained or supplied from several geographical locations, several logistical relationships may exist for one source of supply.

The LogisticRelationship may occur in the following complete and disjoint specializations (independent of the specialization of the SourceOfSupply): ExternalProcurementLogisticRelationship (a type of logistical relationship that contains all the parameters for external procurement), InternalProcurementLogisticRelationship (a type of logistical relationship that contains all the parameters for internal procurement) and InternalProductionLogisticRelationship (a type of logistical relationship that contains all the parameters for in-house production).

The node LogisticRelationship may contain the following elements: UUID (an alternative key—Universal identifier of the logistical relationship), SystemAdministrativeData (the administrative data recorded by the system. This data includes system users and change dates/times), SenderLocationUUID (universal identifier of the geographical starting point of the logistical relationship), RecipientLocationUUID (universal identifier of a geographical end point of the logistical relationship or the location that produces the material), SenderTransportationZoneUUID (universal identifier of the transportation zone where the procurement relationship starts), RecipientTransportationZoneUUID (universal identifier of the transportation zone where the procurement relationship ends), SenderSupplyPlanningAreaUUID (universal identifier of the requirements planning area where the logistical relationship starts), RecipientSupplyPlanningAreaUUID (universal identifier of the requirements planning area where procurement relationship ends or the requirements planning area where the material is produced), BaseObjectNodeReference (an alternative key—Universal reference of the object from which the logistic relationship was replicated. A logistic relationship may be replicated from a material specific transportation lane, from an item of a purchasing contract or a released planning production model. The UUID should be specified, the ObjectNodeId should not be specified), ProcurementCategoryCode (coded representation of the procurement category), ValidityPeriod (time period during which the logistical relationship is valid), PriorityValue (priority according to which the logistical relationship is taken into account in procurement), GoodsIssueDuration (duration of the goods issue process), GoodsIssueDurationRelevanceIndicator (indicates whether the GoodsIssueDuration has to be considered), GoodsReceiptDuration (duration of the goods receipt process), GoodsReceiptDurationRelevanceIndicator (indicates whether the GoodsReceiptDuration has to be considered), PlannedProductionFixedDuration (planned, fixed duration of production), PlannedProductionVariableDuration (planned, variable duration of production), MinimumLotsizeQuantity (smallest permitted lot size during transportation), MinimumLotsizeQuantityTypeCode (coded representation of the type of the MinimumLotsizeQuantity), MaximumLotsizeQuantity (largest permitted lot size during transportation), MaximumLotsizeQuantityTypeCode (coded representation of the type of the MaximumLotsizeQuantity) and Status (current status of the LogisticRelationship. It is defined by the data type SourceOfSupplyLogisticRelationshipStatus and may comprise the following status variables: LifeCycleStatusCode (describes stages in the life of a LogisticRelationship), SourceOfSupplyLifeCycleStatusCode (describes the LifeCycle stage of the root node) and OverallLifeCycleStatusCode (summarizes the LifeCycleStatus and the SourceOfSupplyLifeCycleStatus). In some cases, the transportation zone contains geographical locations that may be considered collectively for modeling or planning transportation routes or transportations. The zone can be defined by listing all locations that it contains or by the attributes of the locations that it contains such as country, zip code, or region.

The LogisticRelationship node of the example SOS BO may have the following inbound aggregation relationships:
From the business object Location: RecipientLocation—Identifies the target location of the geographical point that is linked logistically.
From the business object TransportationLane/ValidMaterials: TransportationLaneValidMaterials—The material-specific transportation lane to which the source of supply refers.
From the business object PurchasingContract/Item: PurchasingContractItem—The purchasing contract item for which the source of supply was created.
From the business object ReleasedPlanningProductionModel: ReleasedPlanningProductionModel—The released planning production model to which the source of supply refers.

The LogisticRelationship node of the example SOS BO of FIG. 2 may have the following inbound association relationships:
From the business object Location: SenderLocation—Identifies the starting location of the geographical points that are linked logistically.
From the business object TransportationZone: SenderTransportationZone—Transportation zone where the procurement relationship starts.
From the business object TransportationZone: RecipientTransportationZone—Transportation zone where the procurement relationship ends.
From the business object SupplyPlanningArea: SenderSupplyPlanningArea—Identifies the initial planning area.
From the business object SupplyPlanningArea: RecipientSupplyPlanningArea—Identifies the target planning area.
From the business object Identity: CreationIdentity—Identifies the Identity that created the SourceOfSupply
From the business object Identity: LastChangedIdentity—Identifies the Identity that changed the SourceOfSupply

Also, the LogisticRelationship node of the example SOS BO of FIG. 2 may have a composition relationship to the subordinate node LogisticRelationshipReferenceCollection. The LogisticRelationship node of the example SOS BO of FIG. 2 may also include the following queries:
QueryByProductAndRecipientOrganisationalCentre: Typically provides a list of all logistical relationships for a particular product and a particular organizational center that is the recipient of this product. The logistical relationships can be valid for the specified point in time. The query elements can be defined by the GDT SourceOfSupplyLogisticRelationshipProductAndRecipientOrganisationalCentreQueryElements, which may include the following elements: SourceOfSupplyProductUUID (note: Logistic relationships that refer to the product category of the specified product, to a product category on the above hierarchy level of the product category of the specified product or to all materials can also be returned), SourceOfSupplyCatalogueReference, SourceOfSupplyProductSellerID, SourceOfSupplyProductTypeCode, SourceOfSupplyRecipientOrganisationalCentreUUID, RecipientLocationUUID (logistic relationships that can be defined for RecipientLocations on the above level in the location hierarchy can also be returned. Logistic relationships that can be defined for a RecipientTransportationZone that contains the location can also be returned), SourceOfSupplySenderBusinessPartnerUUID, RequirementDateTime, RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode, SourceOfSupplyBaseObjectTypeCode, SourceOfSupplyBaseObjectNodeTypeCode and OverallLifeCycleStatusCode.
QueryByProductAndRecipientBusinessPartner: Typically provides a list of all logistical relationships for a particular product and a particular business partner that is the recipient of this product. The logistical relationships can be valid for the specified point in time. The query elements can be defined by the GDT SourceOfSupplyLogisticRelationshipProductAndRecipientBusinessPartnerQueryElements, which may include the following elements: SourceOfSupplyProductUUID (logistic relationships that refer to the product category of the specified product, to a product category on the above hierarchy level of the product category of the specified product or to all materials can be returned), SourceOfSupplyCatalogueReference, SourceOfSupplyProductSellerID, SourceOfSupplyProductTypeCode, SourceOfSupplyRecipientBusinessPartnerUUID, RecipientLocationUUID (logistic relationships that can be defined for RecipientLocations on the above level in the location hierarchy can be returned. Logistic relationships that can be defined for a RecipientTransportationZone that contains the location can also be returned), SourceOfSupplySenderBusinessPartnerUUID, RequirementDateTime, RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode, SourceOfSupplyBaseObjectTypeCode, SourceOfSupplyBaseObjectNodeTypeCode and OverallLifeCycleStatusCode.
QueryByProductCategoryAndRecipientOrganisationalCentre: Typically provides a list of all logistical relationships for a particular product category and a particular organizational center that is the recipient of the products in this product category. The logistical relationships can be valid for the specified point in time. The query elements can be defined by the GDT SourceOfSupplyLogisticRelationshipProductCategoryAndRecipientOrganisationalCentreQueryElements, which may include the following elements: SourceOfSupplyProductCategoryHierarchyProductCategoryUUID (logistic relationships that refer to a product category on the above hierarchy level of the product category can be returned), SourceOfSupplyRecipientOrganisationalCentreUUID, RecipientLocationUUID (logistic relationships that can be defined for RecipientLocations on the above level in the location hierarchy can be returned. Logistic relationships that can be defined for a RecipientTransportationZone that contains the location can also be returned), SourceOfSupplySenderBusinessPartnerUUID, RequirementDateTime, RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode, SourceOfSupplyBaseObjectTypeCode, SourceOfSupplyBaseObjectNodeTypeCode and OverallLifeCycleStatusCode.
QueryByProductCategoryAndRecipientBusinessPartner: Typically provides a list of all logistical relationships for a particular product category and for a particular business partner that is the recipient of the products in this product category. The logistical relationships can be valid for the specified point in time. The query elements can be defined by the data type SourceOfSupplySourceOfSupplyLogisticRelationshipProductCategoryAndRecipient BusinessPartnerQueryElements, which may include the following elements: SourceOfSupplyProductCategoryHierarchyProductCategoryUUID (logistic relationships that refer to a product category on the above hierarchy level of the product category can be returned), SourceOfSupplyRecipientBusinessPartnerUUID, RecipientLocationUUID (logistic relationships that can be defined for RecipientLocations on the above level in the location hierarchy can also be returned. Logistic relationships that can be defined for a RecipientTransportationZone that contains the location can also be returned), SourceOfSupplySenderBusinessPartnerUUID, RequirementDateTime, RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode, SourceOfSupplyBaseObjectTypeCode, SourceOfSupplyBaseObjectNodeTypeCode and OverallLifeCycleStatusCode.
QueryByProductAndRecipientLocation: Typically provides a list of all logistical relationships for a particular production and a particular geographical end point of the logistical relationship. The logistical relationships can be valid for the specified point in time. The query elements can be defined by the GDT SourceOfSupplyLogisticRelationshipProductAndRecipientLocationQueryElements, which may include the following elements: SourceOfSupplyProductUUID (logistic relationships that refer to the product category of the specified product, to a product category on the above hierarchy level of the product category of the specified product or to all materials can also be returned), SourceOfSupplyProductTypeCode, RecipientLocationUUID, (logistic relationships that can be defined for RecipientLocations on the above level in the location hierarchy can also be returned. Logistic relationships that can be defined for a RecipientTransportationZone that contains the location can also be returned), RequirementDateTime, RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode and OverallLifeCycleStatusCode.
QueryByProductAndRecipientTransportationZone: Typically provides a list of all logistical relationships for a particular product and for a particular transportation zone where the procurement relationship ends. The logistical relationships can be valid for the specified point in time. The query elements can be defined by the data type SourceOfSupplySourceOfSupplyLogisticRelationshipProductAndRecipientTransportationZoneQueryElements, which may include the following elements: SourceOfSupplyProductUUID (logistic relationships that refer to the product category of the specified product, to a product category on the above hierarchy level of the product category of the specified product or to all materials can also be returned), SourceOfSupplyProductTypeCode, RecipientTransportationZoneUUID, RequirementDateTime, RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode and OverallLifeCycleStatusCode.
QueryByProductAndRecipientSupplyPlanningArea: Typically provides a list of all logistical relationships for a particular product and for a particular requirements planning area where the procurement relationship ends. The logistical relationships can be valid for the specified point in time. The query elements can be defined by the data type SourceOfSupplySourceOfSupplyLogisticRelationshipProductAndRecipientSupplyPlanningAreaQueryElements, which may include the following elements: SourceOfSupplyProductUUID (logistic relationships that refer to the product category of the specified product, to a product category on the above hierarchy level of the product category of the specified product or to all materials can also be returned), SourceOfSupplyProductTypeCode, RecipientSupplyPlanningAreaUUID (logistic relationships that can be defined for RecipientLocations that belong to this supply planning area can also be returned. Logistic relationships that can be defined for RecipientOrganisationalCentres that belong to locations of this supply planning area can also be returned), RequirementDateTime (the system returns logistical relationships for which the RequirementDateTime is larger or the same as the ValidityPeriodStartDateTime, and for which the RequirementDateTime is smaller or the same as the ValidityPeriodEndDateTime), RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode and OverallLifeCycleStatusCode. In some cases, a supply planning area is an area in planning for which the availability of materials on time might be guaranteed. To achieve this, the supply planning area groups requirements, stocks, and further requirement coverage elements of a site for consumption in the net requirements calculation in material requirements planning.
QueryByProductCategoryAndRecipientLocation: Typically provides a list of all logistical relationships for a particular production category and a particular geographical end point of the logistical relationship. The logistical relationships can be valid for the specified point in time. The query elements can be defined by the data type SourceOfSupplyLogisticRelationshipProductCategoryAndRecipientLocationQueryElements, which may include the following elements: SourceOfSupplyProductCategoryHierarchyProductCategoryUUID (logistic relationships that refer to a product category on the above hierarchy level of the product category can also be returned), RecipientLocationUUID, RequirementDateTime (the system returns logistical relationships for which the RequirementDateTime is larger or the same as the ValidityPeriodStartDateTime, and for which the RequirementDateTime is smaller or the same as the ValidityPeriodEndDateTime), RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity) and OverallLifeCycleStatusCode.
QueryBySourceOfSupplyAndRecipientLocation: Typically provides a list of all logistical relationships that belong to a particular source of supply, have a particular geographical end point, and that can be valid for the specified point in time. The query elements can be defined by the GDT SourceOfSupplyLogisticRelationshipSourceOfSupplyAndRecipientLocationQueryElements, which may include the following elements: SourceOfSupplyUUID, RecipientLocationUUID (logistic relationships that can be defined for RecipientLocations on the above level in the location hierarchy can also be returned. Logistic relationships that can be defined for a RecipientTransportationZone that contains the location can also be returned), RequirementDateTime (the system returns logistical relationships for which the RequirementDateTime is larger or the same as the ValidityPeriodStartDateTime, and for which the RequirementDateTime is smaller or the same as the ValidityPeriodEndDateTime), RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode and OverallLifeCycleStatusCode.
QueryBySourceOfSupplyAndRecipientSupplyPlanningArea: Typically provides a list of all logistical relationships that belong to a particular source of supply, have a particular supply planning area at which the procurement relationship ends, and that can be valid for the specified point in time. The query elements can be defined by the data type SourceOfSupplyLogisticRelationshipSourceOfSupplyAndRecipientSupplyPlanningAreaQueryElements, which may include the following elements: SourceOfSupplyUUID, RecipientSupplyPlanningAreaUUID (logistic relationships that can be defined for RecipientLocations that belong to this supply planning area can also be returned. Logistic relationships that can be defined for RecipientOrganisationalCentres that belong to locations of this supply planning area can also be returned), RequirementDateTime (the system returns logistical relationships for which the RequirementDateTime is larger or the same as the ValidityPeriodStartDateTime, and for which the RequirementDateTime is smaller or the same as the ValidityPeriodEndDateTime), RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode and OverallLifeCycleStatusCode.
QueryByPurchasingContractItemAndRecipientLocation: Typically provides a list of all logistical relationships for a particular item of a particular contract and a particular geographical end point that can be valid for the specified point in time. The query elements can be defined by the data type SourceOfSupplyLogisticRelationshipPurchasingContractItemAndRecipientLocation QueryElements, which may include the following elements: PurchasingContractItemUUID, RecipientLocationUUID (logistic relationships that can be defined for RecipientLocations on the above level in the location hierarchy can also be returned. Logistic relationships that can be defined for a RecipientTransportationZone that contains the location can also be returned), RequirementDateTime (the system returns logistical relationships for which the RequirementDateTime is larger or the same as the ValidityPeriodStartDateTime, and for which the RequirementDateTime is smaller or the same as the ValidityPeriodEndDateTime), RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode and OverallLifeCycleStatusCode.
QueryByPurchasingContractItemAndRecipientSupplyPlanningArea: Typically provides a list of all logistical relationships for a particular item of a particular contract and a particular supply planning area at which the procurement relationship ends, that can be valid for the specified point in time. The query elements can be defined by the data type SourceOfSupplyLogisticRelationshipPurchasingContractItemAndRecipientSupplyPlanningAreaQueryElements, which may include the following elements: PurchasingContractItemUUID, RecipientSupplyPlanningAreaUUID (logistic relationships that can be defined for RecipientLocations that belong to this supply planning area can also be returned. Logistic relationships that can be defined for RecipientOrganisationalCentres that belong to locations of this supply planning area can also be returned), RequirementDateTime (the system returns logistical relationships for which the RequirementDateTime is larger or the same as the ValidityPeriodStartDateTime, and for which the RequirementDateTime is smaller or the same as the ValidityPeriodEndDateTime), RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode and OverallLifeCycleStatusCode.
QueryByProductIDAndRecipientSupplyPlanningAreaID: Typically provides a list of all logistical relationships for a particular product and for a particular requirements planning area where the procurement relationship ends. The logistical relationships can be valid for the specified point in time. The query elements can be defined by the datatype SourceOfSupplyLogisticRelationshipProductIDAndRecipientSupplyPlanningAreaID QueryElements, which may include the following elements: Product_IdentificationProductID, SourceOfSupplyProductTypeCode, RecipientSupplyPlanningArea_ID (logistic relationships that can be defined for RecipientLocations that belong to this supply planning area can also be returned. Logistic relationships that can be defined for RecipientOrganisationalCentres that belong to locations of this supply planning area can also be returned), RequirementDateTime (the system returns logistical relationships for which the RequirementDateTime is larger or the same as the ValidityPeriodStartDateTime, and for which the RequirementDateTime is smaller or the same as the ValidityPeriodEndDateTime), OverallLifeCycleStatusCode and CreationUserAccountID.
QueryByRecipientLocationIDAndRecipientTransportationZoneID: Typically provides a list of all logistical relationships for a particular location or transportation zone where the procurement relationship ends. The query elements can be defined by the datatypeSourceOfSupplyLogisticRelationshipRecipientLocationIDAndRecipientTransportationZonelDQueryElements, which may include the following elements: RecipientLocation_ID, RecipientTransportationZone_ID and OverallLifeCycleStatusCode.
QueryByElements: Typically provides a list of all logistical relationships which refer to a particular business object or to a node of a business object. The query elements can be defined by the data type SourceOfSupplyLogisticRelationshipElementsQueryElements, which may include the following elements: LocationUUID, TransportationZoneUUID, SupplyPlanningAreaUUID, BaseObjectNodeReference and OverallLifeCycleStatusCode.
QueryByPurchasingContractIdAndPurchasingContractItemID: Typically provides a list of all logistical relationships which refer to a particular purchasing contract item. The query elements can be defined by the data type SourceOfSupplyLogisticRelationshipPurchasingContractIdAndPurchasingContractItemldQueryElements, which may include the following elements: LogisticRelationshipReferenceCollectionPurchasingContractID, LogisticRelationshipReferenceCollectionPurchasingContractItemID and OverallLifeCycleStatusCode.

The LogisticRelationship node of the example SOS BO of FIG. 2 may include a LogisticRelationshipReferenceCollection node that contains the human-readable Identifiers for the References of the LogisticRelationship. The node LogisticRelationshipReferenceCollection may contain the following elements, which may be defined by the data type SourceOfSupplyLogisticRelationshipReferenceCollectionElements: PurchasingContractID (Unique identifier of a contract that defines the business relationship), PurchasingContractItemID (Unique identifier of an item of the contract that defines the business relationship) and PurchasingContractItemKey (an alternative key of the LogisticRelationshipReferenceCollection. Elements of the alternative key may include PurchasingContractId and PurchasingContractItemId).

It should be noted that prior to operation of the sourcing system 100, a plurality of source of supply business objects 210 containing data representative of the various supply sources available to sourcing system 100 may have been created and stored in the business object repository 200 in memory 130 and/or some other persistence.

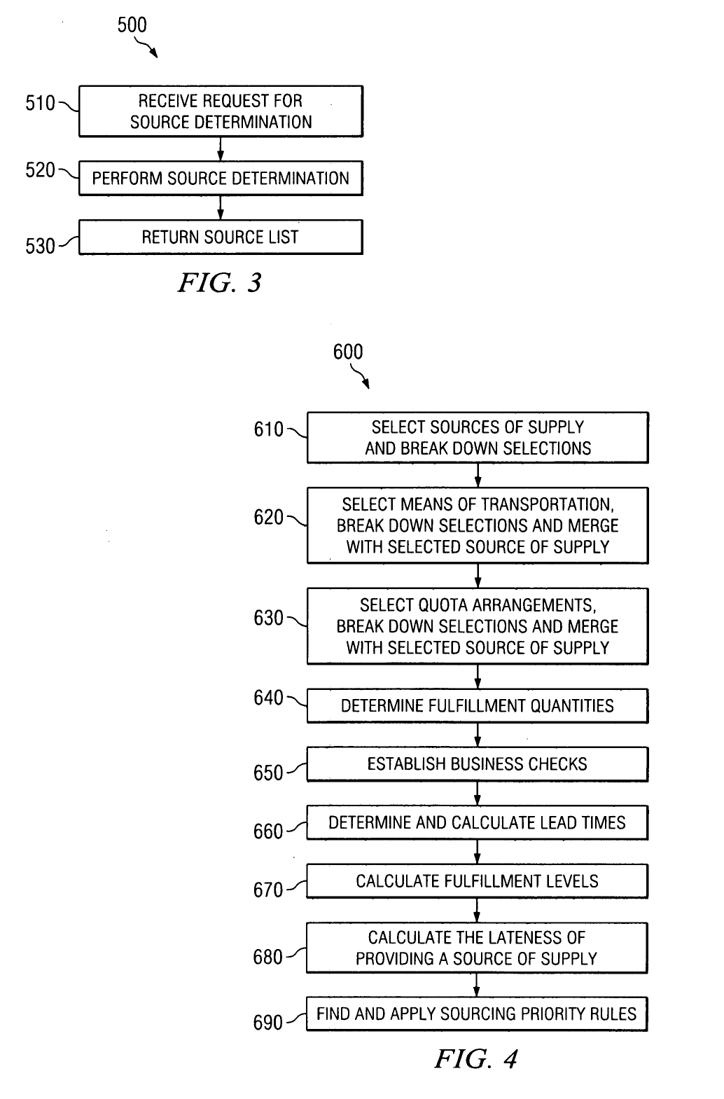

FIG. 3 is a flowchart illustrating an example method 500 according to which the sourcing system 100 may operate. First, sourcing system 100 receives a request for a source determination, as shown in block 510. For example, an application running in a client 400 calls the sourcing system 100. The application identifies a particular product, a product category, or a catalog reference for which the source determination is desired. The application may also identify a product recipient such as a company, a location or a supply planning area. A supply planning area may refer to an area in planning for which the availability of materials on time is guaranteed. To achieve this, the supply planning area groups requirements, stocks, and further requirement coverage elements of a site for consumption in the net requirements calculation in material requirements planning.

The application calling sourcing system 100 may control the sourcing determination process performed by the sourcing engine in a number of ways. For example, the business application may pass selection parameters to the sourcing engine. In this example, these selection parameters could be on a very detailed level (such as on Product level), but there can also be sources of supply that were maintained on a higher level (e.g. on Product-Category level). The sourcing engine may further enrich the selection with higher maintenance possibilities (such as the Product Categories). A further service may break down a higher maintained source of supply to the selected criteria, indicating that the product category specific source of supply will be provided with the selected product.

Also, each application that calls the sourcing engine may have a sourcing profile associated with it and bundled with each sourcing profile may be parameters that control the source determination process. In addition, the calling application may be associated with a particular business configuration and each configuration may have controls, e.g., a sourcing priority rule, associated with it. Thus, when a given application associated with a given business configuration calls sourcing system 100, the sourcing engine may automatically to the sourcing determination, apply the sourcing profile and controls associated with application and context, respectively.

Next, sourcing system 100 performs the source determination based on the parameters provided by or associated with the calling application, as shown in step 520. FIG. 4 is a flowchart illustrating an example method 600 followed by the sourcing system 100 in performing this source determination.

As shown in FIG. 4, sourcing system 100 first selects sources of supply, as indicated in step 610. First, sources of supply may be selected based on several filter criteria, such as product specific alternatives (e.g., product, product category, or catalog reference), recipient specific alternatives (e.g., recipient business partner, recipient organizational center, recipient location, recipient transportation zone, or recipient supply planning area), or sender business partner. Queries of the sources of supply BO may be used to select the Sources of Supply matching the filter criteria. In addition, within these queries, the filter criteria may be enriched. Examples of such enrichments include products with product categories, products with all-product-entries, recipient locations with recipient transportation zones, recipient locations with higher recipient locations of a location hierarchy and recipient supply planning areas with recipient organizational centers.

Control parameters, such as from the sourcing profile for the application, may influence the Sources of Supply selected through the queries. For example, lotsize quantity may be used to check the lot size ranges, earliest planning datetime or requirement datetime may be used to check the validity in dependency of the control parameter validity relation.

After sources of supply have been selected through the queries, the selected sources of supply may be broken down to more detailed levels of attributes. For example, the selected sources of supply may be broken down using the following sequence of detail levels: Location related detail level sequence (e.g., location specific sources of supply, higher location specific sources of supply, and then transportation zone specific sources of supply), after location related detail level, the product specific detail level sequence (e.g., product specific sources of supply, product category specific sources of supply, and then all product entry specific sources of supply).

Also, the following methods may be used to break down the selected sources of supply: recipient transportation zone specific sources of supply with selected recipient locations, higher recipient location specific sources of supply with selected recipient locations of a location hierarchy, recipient organizational center specific sources of supply with selected recipient supply planning areas, product category specific sources of supply to selected products, and all-product-entry specific sources of supply to selected products.

Following the selection and break down of sources of supply, sourcing system 100 selects means of transportation, as shown in step 620. This selection may be based on filter criteria such as list of means of transportation ids and extracted filter criteria of the selected sources of supply, such as the valid materials-node of the transportation lane BO. Queries of the BO transportation lane may be used to select the means of transportation. In addition, within these queries, the filter criteria may be enriched. Examples of such enrichments include arbitrary means of transport to selected means of transport. Also, control parameters, as from the sourcing profile for the application, may influence the means of transportation selected through the queries. For example earliest planning DateTime or requirement DateTime to check the validity in dependency of the control parameter “Validity relation”, validity relation to the sender leads to a selection from the earliest planning DateTime to the future and validity relation to the recipient leads to a selection exactly with the requirement DateTime.

After the means of transportation are selected, the higher means of transportation may be broken down to selected means of transportation IDs. The selected and broken down means of transportation may then be merged with the selected source of supply from step 610 into one Sourcing List.

Next, sourcing system 100 selects quota arrangements, as shown in step 630. The filter criteria for selecting supply quota arrangements may be determined from the attributes of selected sources of supply, such as product and recipient organizational center. Queries of the BO quota arrangement may be used to select the supply quota arrangements matching the filter criteria. In addition, within these queries, the filter criteria may be enriched. Examples of such enrichments include products with product categories and products with all-product-entries. Also, control parameters, as from the sourcing profile for the application, may influence the quota arrangement selected through the queries. For example earliest planning DateTime or requirement DateTime to check the validity in dependency of the control parameter “validity relation”, validity relation to the sender leads to a selection from the earliest planning DateTime to the future and validity relation to the recipient leads to a selection exactly with the requirement DateTime.

After supply quota arrangements have been selected through the queries, the selected supply quota arrangements may be broken down to more detailed levels of attributes. For example, the selected supply quota arrangements may be broken down using the following sequence of detail levels: product specific supply quota arrangements, product category specific supply quota arrangements, and all product entry specific supply quota arrangements.

Also, the following methods may be used to break down the selected supply quota arrangements: product category specific supply quota arrangements to selected products and all-product-entry specific supply quota arrangements to selected products. The selected and broken down supply quota arrangements may then be merged with the selected source of supply from step 610 into one sourcing list by splitting the validities.

Next, sourcing system 100 determines fulfillment quantities, as shown in step 640. One example of how this determination may be made involves first determining the allocated quantities related to sources of supply and supply quota arrangement items of non-simulated receipts with queries of the BO sourcing allocation. Then, a call back may be made into the application that called sourcing system 100 using an application exit to determine open quantities based on sources of supply and supply quota arrangement Items of simulated receipts on run time. Then, the quantities of the non-simulated and simulated receipts may be cumulated based on sources of supply and supply quota arrangement items.

Next, sourcing system 100 establishes or implements business checks, as shown in step 650. One way in which these business checks may be established begins with checking the validity period in dependency of the control parameter “validity relation” according to the selection parameter requirement DateTime. If the validity relates to the sender subtract the calculated consumer duration from the requirement DateTime before checking the validity period. The sourcing engine may check the maximum lateness duration. The sourcing engine may also check the lotsize range according the selection parameter lotsize quantity in consideration of the unit conversion. The sourcing engine may also check the existence of the supply planning information within the product at the sender or recipient supply planning area according the control parameter “product break down code”.

After business checks are established, sourcing system 100 determines and calculates lead times, as shown in step 660. One method through which these lead times may be calculated involves first overwriting with the lead times from BO product, if the relevance indicators of this lead times, which established at the source of supply switched off: planned delivery duration, goods issue duration, goods receipt duration. Also, calculation of lead times involves the following: (a) re-calculation of shipment duration in case of a source of supply, which was selected over a location and relates to an recipient transportation zone. The maintained shipment duration to the transportation zone will be recalculated in relation to the straight-line-distance to the selected location; (b) calculation of total production planning duration (estimated duration at the source of supply).

Next, sourcing system 100 calculates fulfillment levels, as shown in step 670. One method for doing so involves first calculating the exceeded fulfillment level of the target quantity of the source of the supply. Then, calculate the fulfillment levels of the competing supply quota arrangement items in relation to each other.

Sourcing system 100 then calculates the lateness of providing a source of supply, as shown in step 680. Here, lateness describes the time a material will be provided after the requirement time as it has been given by the application. To determine the lateness a simple scheduling may be performed.

Scheduling parameters are different for the procurement possibility internal production as follows: production duration (estimated duration at the source of supply) related to production calendar responsible factory calendar calculation of the consumer and supplier lead time according chapter: source determination considering lead time and validity calculation of lateness duration with the difference of the requirement time and the current and the sum of supplier and consumer lead time.

Scheduling parameters are different for the procurement possibility external procurement as follows: planned delivery duration (source of supply/material master) related to the supplier calendar (ship from location) goods receipt processing time (source of supply/material master/transportation lane) related to the factory calendar calculation of the consumer and supplier lead time according chapter: source determination considering lead time and validity calculation of lateness duration with the difference of the requirement time and the current and the sum of supplier and consumer lead time.

Scheduling parameters can be different for the procurement possibility internal stock transfer as follows: goods issue processing time (source of supply/material master/transportation lane) related to the factory calendar (ship from location) transportation duration (transportation lane) related to the transportation calendar (means of transportation) goods receipt processing time (source of supply/material master/transportation lane) related to the factory calendar (recipient location) calculation of the consumer and supplier lead time according chapter: source determination considering lead time and validity calculation of lateness duration with the difference of the requirement time and the current and the sum of supplier and consumer lead time. Generally, stock transfers include exchange of material between organizational centers, each of which are a business unit within an organizational structure (for example, organizational plan, financial structure, geographical structure) of a particular company.

Scheduling parameters are different for the procurement possibility 3rd party direct ship as follows: planned delivery duration (source of supply/material master) related to the supplier calendar (ship from location) transportation duration (transportation lane) related to the transportation calendar (means of transportation) calculation of the consumer and supplier lead time according chapter: source determination considering lead time and validity calculation of lateness duration with the difference of the requirement time and the current and the sum of supplier and consumer lead time.

Referring again to FIG. 4, sourcing system 100 finds and applies sourcing priority rules, as shown in step 690. One way for accomplishing this involves first finding the relevant sourcing priority rule by the sourcing application code or the optional control parameter sourcing priority rule code. Next, sourcing system 100 finds the appropriate sub priority-rule within the selected sourcing priority rule for competing sources of supply in consideration of the following detail level sequence: product specific sourcing sub-priority rule, product category specific sourcing sub-priority rule, general sourcing sub-priority rule. Then, sourcing system 100 sorts the sourcing list according to the sort criteria within the sourcing sub priority-rule. The sourcing priority rule and the default sourcing-sub priority-rule may be found according to the sourcing application. Optionally the sourcing-sub-priority-rules may be found by products or product categories. The result shall be a sorted list according the priority rules. For example, sourcing priority rules can be dedicated to products, product categories, or others that are generally usable. In this example, the most detailed (special) sourcing priority rule can be dedicated to a product. If the sourcing engine doesn't find a product-specific one, say because the customer maintained it on a higher level, then the sourcing engine can look for a product category-specific one. The highest definition of a sourcing priority rule is often a general one, and the sourcing engine takes this one, if no product-specific, product category-specific, or other middle tier one were found.

Sourcing system 100 may also allow sorting of the sources of supply by each attribute of the output structure, e.g., the sourcing list. The attributes have to be classified by:
Static attributes: value given by property of the source of supply (e.g. priority of source of supply, procurement type, source object type or selling party);
Dynamic attributes: value calculated for each source, when sourcing engine is called (e.g. costs, lateness, fulfillment of guaranteed minimum value or quota rate);
Numerical attributes: rank of sources of supply can be directly derived; direction of sorting is inherently given (e.g. priority of source of supply, costs, lateness, fulfillment of guaranteed minimum value or quota rate); and
Non-numerical attributes: surrogate needed to express preferences like a priority, which is assigned to particular attribute values (e.g. procurement type, source object type or selling party).
   The sourcing system 100 may use a default prioritizing rule. In an embodiment of the invention, the default prioritizing rule prioritizes based on at least one of the following example criteria: priority of source of supply, procurement type, quota rate, source object type, lateness duration and fulfillment of target quantity. A user may configure the default prioritizing rule by selecting the criteria used by the rule.

Returning to FIG. 3, the sorted sourcing list is returned to the application that called the sourcing engine, as shown in block 530. It will be understood that the foregoing methods are for illustration purposes only and that the described or similar processes and techniques may be performed at any appropriate time, including concurrently, individually, or in combination. In addition, many of the steps in this disclosure may take place simultaneously and/or in different orders than as shown. Moreover, system 100 may use or implement similar methods with additional steps, fewer steps, and/or different steps, so long as the methods remain appropriate.

Although this disclosure has been described in terms of certain embodiments and generally associated methods, alterations and permutations of these embodiments and methods will be apparent to those skilled in the art. For example, certain embodiments of system 100 may be a standalone, but networked, client that retrieves local information, identifies the context of the local user, and provides presentation elements associated with remote objects, applications, or other data accessible via the network. Accordingly, the above description of example embodiments does not define or constrain this disclosure. Other changes, substitutions, and alterations are also possible without departing from the spirit and scope of this disclosure.

What is claimed is:

1. A system for determining supply sources for a product in a service-oriented environment, comprising:
a memory storing one or more business objects, each business object including data related to a supply source; and
one or more processors executing software causing them to:
receive requests for supply source determinations from a plurality of clients across a landscape of heterogeneous applications; and
return to each client that submitted a request, a list of one or more supply sources matching the request based on the one or more supply source business objects.

2. The system of claim 1, wherein at least some of the software executed by the one or more processors comprises interfaces associated with one of the business objects.

3. The system of claim 1, wherein the request received from one of the plurality of clients includes parameters to be used by the one or more processors in creating the list to be returned to the respective client.

4. The system of claim 1, wherein the memory stores a profile for one of the plurality of clients and the one or more processors uses data from the profile to create a list to be returned to the respective client.

5. The system of claim 1, wherein the memory stores priority information corresponding to one of the plurality of clients and the one or more processors uses the priority information for the respective client to prioritize the supply sources on the list to be returned to the respective client.

6. A computerized method for determining supply sources for a product, comprising:
receiving a request from a first client for a source determination for a product, the first client operating in a first environment;
selecting a plurality of supply sources associated with the product;
prioritizing the selected supply sources based on rules to automatically identify a more appropriate supply source for the request; and
receiving a second request from a second client for a source determination for a product, the second client operating in a second environment disparate from the first environment.

7. The method of claim 6, wherein the rules are user-defined rules and relate to a business configuration.

8. The method of claim 6, the prioritization based on financial cost and at least one non-financial cost, the non-financial costs including preferred vendor status, transportation time, product quality, rough capacity decisions for bottlenecks, complexity of order process, and a reputation metric.

9. The method of claim 6, wherein the request includes user-defined parameters and the plurality of supply sources is selected based at least in part on the user-defined parameters.

10. The method of claim 9, wherein the user-defined parameters include parameters related to the product category hierarchy of the product.

11. The method of claim 9, wherein the selection is further based on at least one of the following criteria: procurement type, fulfillment of quota, and sourcing priority.

12. The method of claim 11, at least a first of the selection criteria supplied via a user interface.

13. The method of claim 6, wherein the more appropriate supply source comprises one of transportation lane, purchase contract, scheduling agreement, material costing, and a client-specified source of supply.

14. The method of claim 6 further comprising automatically performing one or more material costing estimates for the first client.

15. The method of claim 6, further comprising:
automatically analyzing product movement; and
communicating a sales determination as the source of supply to the first client.

16. A computerized method for determining supply sources for a product, comprising:
receiving a request from a client for a source determination for a product;
selecting at least one supply source for the product;
selecting a means of transportation for the one or more selected supply sources;
merging the selected means of transportation with the one or more selected supply sources;
selecting a quota arrangement for the one or more selected supply sources;
merging the selected quota arrangement with the one or more selected supply sources; and
automatically prioritizing the one or more selected supply sources based on client-defined rules and business logic.

17. The method of claim 16 further comprising breaking down at least one of the selected supply sources to a more detailed level of information.

18. The method of claim 16 further comprising breaking down at least one of the selected means of transportation to a more detailed level of information.

19. The method of claim 16 further comprising breaking down at least one of the selected quota arrangements to a more detailed level of information.

20. The method of claim 16 further comprising calculating the lateness of providing a source of supply.
